(19) United States
(12) Patent Application Publication
(10) Pub. No.: US 2022/0271536 A1
(43) Pub. Date: Aug. 25, 2022

(54) DEVICE FOR CONNECTING TWO ALTERNATING VOLTAGE NETWORKS AND METHOD FOR OPERATING THE DEVICE

(71) Applicant: Siemens Energy Global GmbH & Co. KG, Muenchen (DE)

(72) Inventors: Holger Mueller, Moehrendorf (DE); Gerd Griepentrog, Gutenstetten (DE); Alexander Rentschler, Bensheim (DE)

(21) Appl. No.: 17/629,475

(22) PCT Filed: Jul. 23, 2019
(86) PCT No.: PCT/EP2019/069810

§ 371 Date: Jan. 24, 2022

(51) Int. Cl. H02J 3/16; H02J 3/18; H02J 3/06

(52) U.S. Cl. CPC H02J 3/16; H02J 3/1814; H02J 3/06

(57) ABSTRACT

A connecting device for connecting two n-phase alternating voltage grids of the same frequency includes n susceptance elements each having continuously variable susceptance values. Through the use of each susceptance element, two connecting conductors, which are associated with one another, of the alternating voltage grids can be connected to one another and the active power exchange between the AC voltage grids can be controlled by varying the susceptance values in a targeted manner. A method for operating the connection device is also provided.

The invention relates to a connecting device for connecting two n-phase AC voltage grids of the same frequency. By way of example, these can be 50 Hz or 60 Hz grids, wherein, in the present context, the same frequency indicates the same predefined nominal frequency.

Medium-voltage and high-voltage grids are usually organized in hierarchical topologies. For example, power is transferred from a high-voltage grid (voltage above 100 kV) to the medium-voltage level (voltage >1 kV) (or vice versa). Different medium-voltage grids are therefore often only connected to one another indirectly by the superordinate high-voltage level.

As a result of the increasing spread of decentralized energy infeeds (photovoltaic, wind power), the distribution grid operators face increasing technical and economic challenges in organizing the corresponding power and energy budget in their grid sections. It is therefore often desirable to transfer active power and reactive power between different medium-voltage grids in a controllable manner. In particular, this also relates to economically independent grid sections. The transfer of power serves, for example, to avoid peaks arising in the power withdrawal from the associated high-voltage grid, as a result of which operating costs can be reduced.

The prior art discloses devices relevant to the art that comprise two power converters that are connected to one another on the DC voltage side and connected respectively to an associated one of the AC voltage grids on the AC voltage side.

This known solution is complex and costly, however, because two power converters designed for the full voltage of the AC voltage grids have to be provided.

Coupling the AC voltage grids via controllable impedances, such as a thyristor controlled reactor (TCR), for example, is also known. This solution is disadvantageously associated with a harmonic component in the resulting current, with the result that variable series resonant circuits or filters are additionally necessary.

It is also possible to couple the two AC voltage grids by means of a phase shift transformer (PST). This is a transformer that varies the phase shift by switching over windings and therefore influences the flow of power between the AC voltage grids. The construction of the PST is very complex, however, since the transformer windings have to be provided with a large number of taps. The flow of power can be influenced only in a stepped manner by means of the switching-over processes. Furthermore, the number or the frequency of the switching-over processes is restricted on account of the limited service life of the mechanical contacts, which in turn has a negative influence on the achievable dynamic response of the PST.

The object of the invention is to propose a device relevant to the art that offers a cost-effective and reliable possibility for coupling two AC voltage grids with different voltage phase angles.

The object is achieved according to the invention by a connecting device relevant to the art that comprises n susceptance elements with continuously variable susceptance values in each case, wherein, by means of each susceptance element, two connecting conductors, that are associated with one another, of the AC voltage grids can be connected to one another and the exchange of active power between the AC voltage grids can be controlled by means of targeted variation of the susceptance values. Each susceptance element is distinguished in particular by the fact that its susceptance value is continuously variable or essentially continuously variable. In the present case, it is assumed that the active losses that may occur within the susceptance elements are negligible. In particular, the conductance value of the susceptance element is significantly lower, for example by a factor of 100, preferably by a factor of 1000 or more, than its highest attainable susceptance value. The susceptance elements can be connected between the corresponding connecting conductors of the AC voltage grids in phases. During operation, a first susceptance element then connects a first connecting conductor of the first AC voltage grid to a first connecting conductor of the second AC voltage grid, and so on, wherein an nth susceptance element connects an nth connecting conductor of the first AC voltage grid to an nth connecting conductor of the second AC voltage grid (directly or indirectly via a transformer). Accordingly, each susceptance element expediently has two connections for connecting to the respective connecting conductors. A corresponding procedure, for example, should be adopted for three-phase AC voltage grids to be connected. Those connecting conductors of the two AC voltage grids that in each case have approximately the same line-to-line voltages and a phase offset relative to one another can be suitably connected to one another by means of the susceptance element. The susceptance value of the ith susceptance element is denoted by Bi. For Bi>0, the susceptance element behaves like a capacitor, and for Bi<0, it behaves like an inductor. The transferable active power Ptrans results in the event that all the susceptance values Bi are equal (Bi=B) in the equation Ptrans=3*B*ULL(1)*ULL(2)*sin(phi), wherein ULL(1) denotes the line-to-line voltage in the first AC voltage grid, ULL(2) denotes the line-to-line voltage in the second AC voltage grid and phi denotes the voltage phase difference between the AC voltage grids. Accordingly, both an exchange of active power between the AC voltage grids can be achieved and a reactive power requirement in the two AC voltage grids can be influenced in a reliable manner by means of the connecting device. The connecting device according to the invention is also simple in terms of construction and cost-effective to operate since it has low active power losses.

For the functioning of the connecting device, it is advantageous for the two AC voltage grids to have a phase offset phi relative to one another, that is to say that the grid voltages of the AC voltage grids have a non-vanishing phase shift or different voltage phase angles at least temporarily during operation. The phase offset that is optimum for the functioning of the connecting device can be suitably established taking the following requirements into account:
As high a transfer of active power as possible between the two AC voltage grids with a limited current through the connecting device, as a result of which the loading of optionally used semiconductors can be limited;
Limited voltage loading of the connecting device, as a result of which the operating costs can be reduced;
Good regulatability and stable operation even in the case of slightly different voltages or in the case of voltage fluctuations in one or in the two AC voltage grids.

The value phi=30° proves to be a good compromise, for example.

A simple implementation of a susceptance element results when the susceptance element comprises a plurality of controllable semiconductor switches and at least one DC-link capacitor. The DC-link capacitor can be selectively connected into the current path or bypassed by means of the semiconductor switches that are semiconductor switches that can suitably be switched off, such as IGBTs, IGCTs or suitable field-effect transistors, for example. Suitable control or clocking therefore allows voltages of any phase angle to be generated at the connections of the susceptance element.

Preferably, each susceptance element comprises a series circuit of switching modules, wherein each switching module comprises a plurality of semiconductor switches that can be switched off and a switching module capacitor as the DC-link capacitor. The use of switching modules of identical construction, for example, allows a modular construction of the susceptance elements. The series circuit of many switching modules enables almost any voltage forms to be generated at the connections of the connecting device. A central control device for controlling the switching modules or actuating the corresponding semiconductor switches can be provided accordingly.

It is considered to be particularly advantageous for each susceptance element to comprise a series circuit of full-bridge switching modules and an inductor LA that can be connected in series between the connecting conductors that are associated with one another. Each susceptance element accordingly comprises a first and a second connection and a series circuit of the full-bridge switching modules that are arranged connected in series between the connections. Overall, a sum voltage uA(t) can be generated by suitable actuation (modulation) of the m full-bridge switching modules connected in series. At the generated voltage uA(t), an AC current iA(t) that corresponds to a desired AC current iAref(t) can be set using the inductor LA.

It should be noted here that other types of switching module can also be used instead of the full-bridge switching modules. For example, arrangements consisting of two 3-level NPC half-bridge switching modules with a split DC-link capacitor or else two 3-level flying capacitor half-bridge switching modules, or similar, are also suitable.

According to one embodiment of the invention, the connecting device also comprises a matching transformer for setting the voltage phase angle. For example, a phase shift of phi=30° can be set by means of the matching transformer. The voltage level can also be adapted by means of the matching transformer if AC voltage grids of different voltages are intended to be coupled to one another. The matching transformer can also serve for galvanic isolation of the AC voltage grids. Furthermore, the leakage inductance of the matching transformer can advantageously be used as the inductance LA, with the result that additional chokes can be dispensed with.

Preferably, the matching transformer comprises what is known as an on-load tap changer. This embodiment makes it possible to react to fluctuating voltages particularly rapidly.

According to a further embodiment of the invention, the connecting device also comprises surge arresters connected in parallel with the susceptance elements. In the case of a fault, for example a single-pole or multi-pole short circuit, there can be a considerably higher voltage present at one or more of the susceptance elements than is the case during normal operation. In an unfavorable case, the DC-link capacitors can be charged beyond a permissible level and can be ultimately destroyed in such a fault case, for example. This disadvantageous consequence of a fault can be avoided by the surge arresters that are metal-oxide arresters, for example. The respective surge arrester can take up the fault current occurring in the case of a fault, as a result of which the associated susceptance element is protected.

According to one embodiment of the invention, the connecting device comprises 2*n susceptance elements, wherein the connecting conductors that are associated with one another can be connected to one another in each case by means of two susceptance elements connected in parallel. The two susceptance elements associated with one another accordingly form two parallel branches. The susceptance elements can be suitably actuated here by means of the control apparatus in such a way that they are operated with a phase offset. The transferable active power can be advantageously doubled with such an arrangement. In this case, for example, the susceptance elements of the parallel branches are actuated in such a way that their susceptance values have reversed arithmetic signs.

The connecting device preferably comprises a transformer, having
a first primary winding that can be connected, or is connected during operation, to a first connecting conductor of a first AC voltage grid,
a second primary winding that can be connected to a second connecting conductor of the first AC voltage grid,
a third primary winding that can be connected to a third connecting conductor of the first AC voltage grid,
a first secondary winding that can be connected to a first connecting conductor of a second AC voltage grid by means of a first susceptance element,
a second secondary winding that can be connected to a second connecting conductor of the second AC voltage grid by means of a second susceptance element,
a third secondary winding that can be connected to a third connecting conductor of the second AC voltage grid by means of a third susceptance element,
a first tertiary winding that can be connected to the first connecting conductor of the second AC voltage grid by means of a fourth susceptance element,
a second tertiary winding that can be connected to the second connecting conductor of the second AC voltage grid by means of a fifth susceptance element,
a third tertiary winding that can be connected to the third connecting conductor of the second AC voltage grid by means of a sixth susceptance element,

wherein the secondary windings and the tertiary winding are each interconnected in star connections that generate a phase offset of pi/3 relative to one another and respectively pi/6 relative to the primary windings.

The invention also relates to a method for operating a connecting device that connects two n-phase AC voltage grids of the same frequency.

The object of the invention is to propose a method of this kind that allows the connecting device to be operated as effectively and reliably as possible.

The object is achieved according to the invention by a method relevant to the art, in which in each case two connecting conductors, that are associated with one another, of the AC voltage grids are connected to one another by means of one of n susceptance elements, wherein the susceptance value of each of the susceptance elements is continuously variable, and a transfer of active power between the AC voltage grids is controlled by means of targeted variation of the susceptance values of the susceptance elements.

The advantages of the method according to the invention correspond in particular to those that have already been described above in connection with the connecting device according to the invention.

Preferably, the voltage phase angle (or the voltage phase difference between the AC voltage grids) is actively set by means of the connecting device. Active setting of the voltage phase angle can advantageously achieve a reduction in the configuration of the susceptance elements. For example, a voltage phase difference phi=30° proves to be particularly advantageous.

This results in uA=0.42 ULL for the voltage to be set at the susceptance elements. Therefore, under certain circumstances, for example, less than a third of full-bridge switching modules are necessary for the susceptance elements compared to conventional systems. The voltage phase angle can be set by means of a matching transformer, for example.

The voltage across the susceptance elements is suitably limited by means of surge arresters connected in parallel with them.

According to one embodiment of the method, the connecting device comprises a transformer, having
a first primary winding that is connected to a first connecting conductor of a first AC voltage grid,
a second primary winding that is connected to a second connecting conductor of the first AC voltage grid,
a third primary winding that is connected to a third connecting conductor of the first AC voltage grid,
a first secondary winding that is connected to a first connecting conductor of a second AC voltage grid by means of a first susceptance element,
a second secondary winding that is connected to a second connecting conductor of the second AC voltage grid by means of a second susceptance element,
a third secondary winding that is connected to a third connecting conductor of the second AC voltage grid by means of a third susceptance element,
a first tertiary winding that is connected to the first connecting conductor of the second AC voltage grid by means of a fourth susceptance element,
a second tertiary winding that is connected to the second connecting conductor of the second AC voltage grid by means of a fifth susceptance element,
a third tertiary winding that is connected to the third connecting conductor of the second AC voltage grid by means of a sixth susceptance element,
   wherein the secondary windings and the tertiary winding are each interconnected in star connections that generate a phase offset of pi/3 relative to one another and respectively pi/6 relative to the primary windings. The susceptance elements connected to the secondary side of the transformer here form a first connecting branch and the susceptance elements connected to the tertiary side of the transformer form a second connecting branch. In this case, the susceptance elements are actuated in such a way that the reactive power requirement of the two connecting branches is compensated for. In this way, it is advantageously possible to achieve a situation in which, overall, no reactive power has to be provided by the two AC voltage grids.

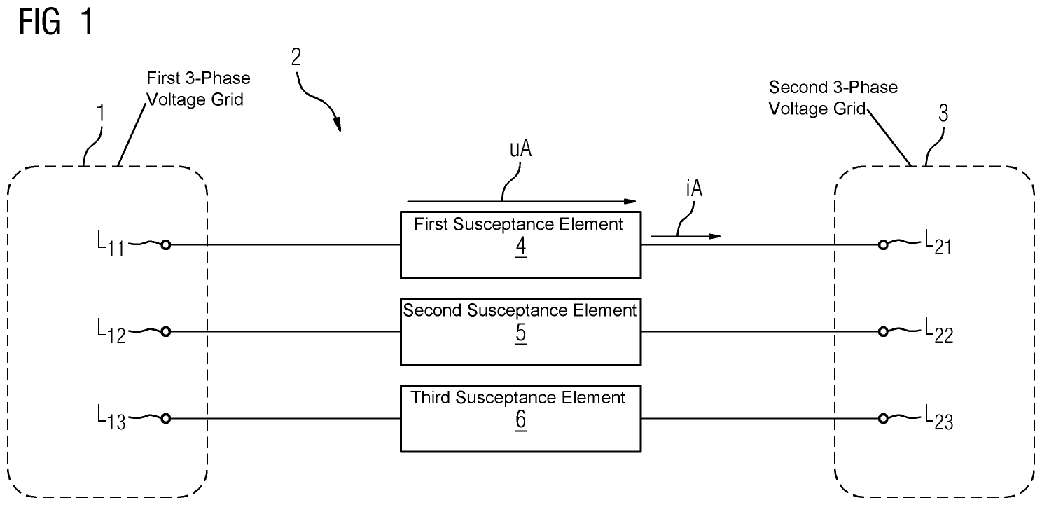

The invention will be explained in more detail below with reference to the exemplary embodiments of FIGS. 1 to 5.

FIG. 1 shows a first exemplary embodiment of a connecting device, according to the invention, in a schematic illustration;

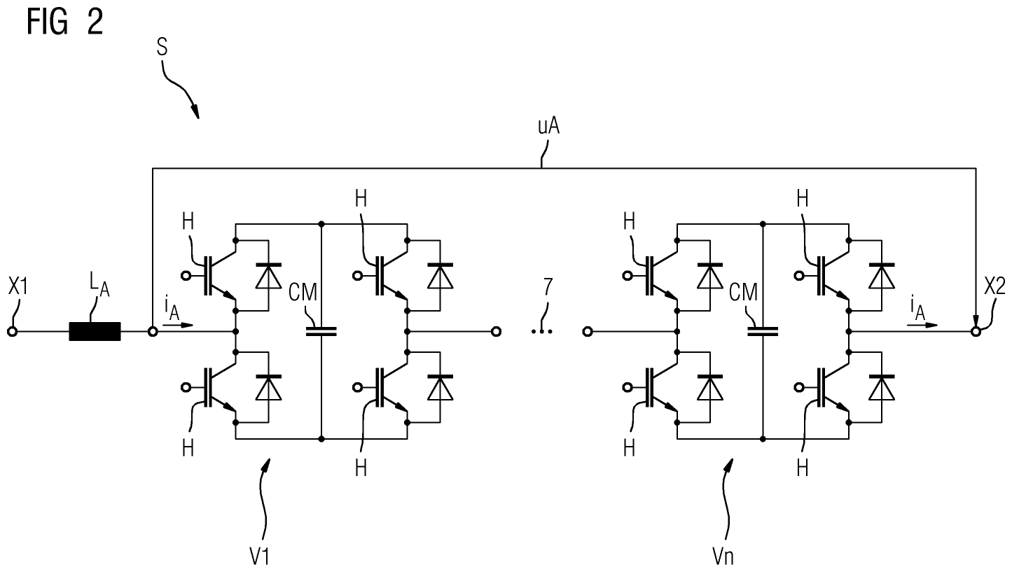

FIG. 2 shows an example of a susceptance element in a schematic illustration;

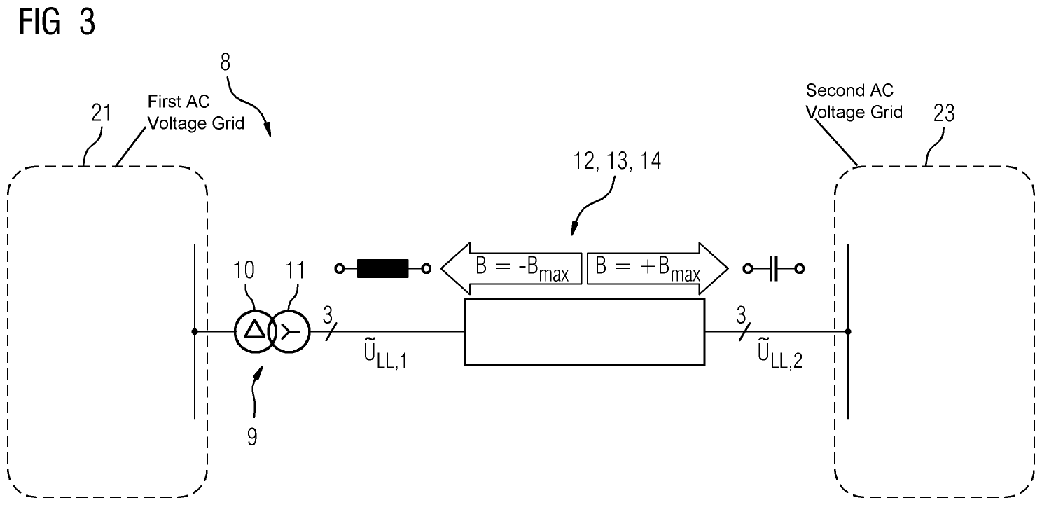

FIG. 3 shows a second exemplary embodiment of a connecting device, according to the invention, in a schematic illustration;

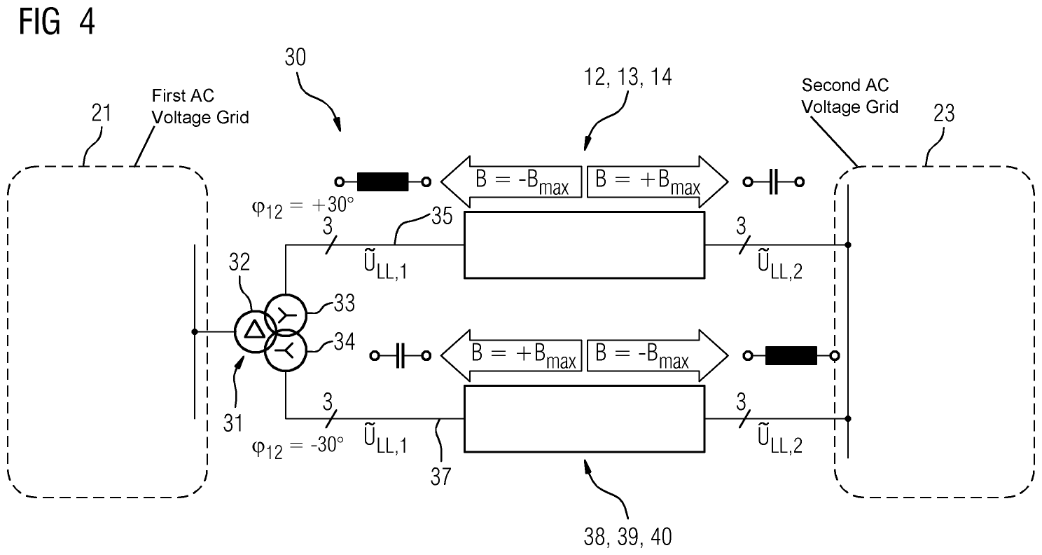

FIG. 4 shows a third exemplary embodiment of a connecting device, according to the invention, in a schematic illustration;

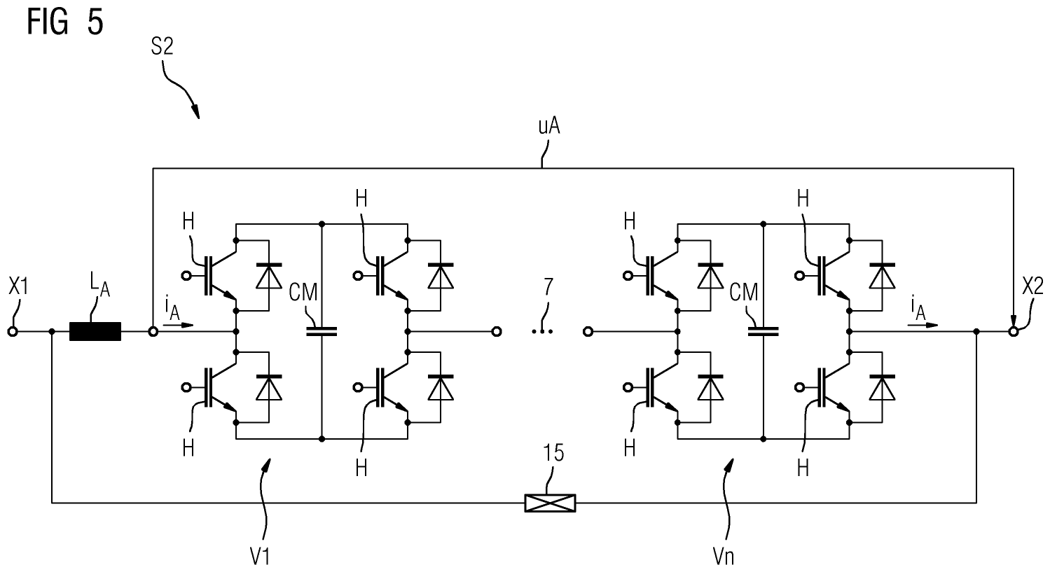

FIG. 5 shows a further example of a susceptance element in a schematic illustration.

FIG. 1 shows a first, three-phase AC voltage grid 1 that is connected to a second, likewise three-phase AC voltage grid 3 by means of a connecting device 2. The first AC voltage grid 1 comprises a first, second and third connecting conductor L11, L12, L13. The second AC voltage grid 3 correspondingly comprises a first, second and third connecting conductor L21, L22, L23. The frequency in the two AC voltage grids is 50 Hz in each case. The connecting device 2 comprises a first susceptance element 4, by means of which the first connecting conductor L11 of the first AC voltage grid 1 is connected to the first connecting conductor L21 of the second AC voltage grid 3. The remaining connecting conductors L12, L13, L23, L33 are correspondingly connected to one another by means of a second or a third susceptance element 5 or 6.

A current iA flows through the first susceptance element 4. The voltage that can be generated at the susceptance element 4 is denoted by uA. The line-to-line voltages in the first AC voltage grid 1 are denoted as ULL(1) and those in the second AC voltage grid 3 are denoted as ULL(2). The susceptance of the susceptance elements 4-6 is denoted by B. The voltages of the two AC voltage grids 1, 3 have a voltage difference of phi relative to one another. The active power Ptrans exchanged between the two AC voltage grids results from

Ptrans=3*B*ULL(1)*ULL(2)*sin(phi). In this equation, active power losses occurring within the susceptance elements are ignored. The active power transferred between the two AC voltage grids can therefore be varied continuously by varying the susceptance values B. Since the susceptance value can assume both positive and negative values, the direction of the transfer of power can additionally also be controlled (bidirectional transport of active power).

At the same time, the first AC voltage grid 1 outputs a reactive power Q1, and the second AC voltage grid 3 outputs a reactive power Q2, in accordance with the following equations:

Q1=3*B*(ULL(1)*ULL(2)cos(phi)−ULL(1)\hat{ }2),

Q2=3*B*(ULL(1)*ULL(2)cos(phi)−ULL(2)\hat{ }2).

The reactive power output of the two AC voltage grids 1, 3 is likewise dependent on the phase difference phi. Overall, the two AC voltage grids 1, 3 cover the reactive power requirement of the susceptance elements.

FIG. 2 shows a susceptance element S that can be used, for example, as one of the susceptance elements 4-6 of FIG. 1. The susceptance element S comprises a first and a second connection X1, X2. A series circuit of full-bridge switching modules V1 . . . Vn is arranged between the connections X1, 2. The number of full-bridge switching modules V1, Vn connected in series is fundamentally arbitrary and can be adapted to the respective application, which is indicated in FIG. 2 by the dotted line 7. A sum voltage uA can be generated at the full-bridge switching modules V1 . . . Vn. This occurs by means of suitable actuation of the semiconductor switches H of the full-bridge switching modules V1 . . . Vn. Each full-bridge switching module V1 . . . Vn also comprises a switching module energy store in the form of a switching module capacitor CM that can be bypassed by means of the semiconductor switches H or connected into the current path. An inductor LA is connected in series with the full-bridge switching modules V1 . . . Vn.

FIG. 3 shows a further connecting device 8. In contrast to the connecting device 2 of FIG. 1, the connecting device 8 comprises a matching transformer 9. The primary windings 10 of the matching transformer 9 are arranged in a delta connection and are connected to the connecting lines of the first AC voltage grid 21. The secondary windings 11 of the matching transformer 9 are interconnected in a star point connection and are connected to three susceptance elements 12, 13, 14. The voltage phase shift phi in the example shown is set to 30° by means of the matching transformer. In this case, the second AC voltage grid 23 leads the first AC voltage grid 21 by 30° (=pi/6). In the first AC voltage grid 21, the voltage in the example shown is 8 kV. The voltage in the second AC voltage grid 23 is 20 kV. The frequency is 50 Hz in both cases. The active power transferred between the AC voltage grids 21, 23 can be approximately 30 MW with a current iA of 850A.

FIG. 4 shows a connecting device 30 that connects the first AC voltage grid 21 to the second AC voltage grid 23. The connecting device 30 comprises a transformer 31. The transformer 31 comprises primary windings 32 that are connected in a delta connection and are connected to associated connecting conductors of the first AC voltage grid 21. The transformer 31 also comprises secondary windings 33 that are interconnected in a star connection and are connected to a first (three-phase) parallel branch 35, and tertiary windings 36 that are likewise interconnected in a star connection and are connected to a second parallel branch 37.

Three susceptance elements 12-14 are arranged in the first parallel branch 35, and three further susceptance elements 38-40 are arranged in the second parallel branch 37. The three susceptance elements connect the secondary windings 33 to the associated connecting conductors of the second AC voltage grid 23. The further susceptance elements 38-40 correspondingly connect the tertiary windings 34 to the correspondingly associated connecting elements of the second AC voltage grid 23.

The secondary windings 33 and the tertiary windings 34 are each interconnected in star connections that generate a phase offset of pi/3 relative to one another and respectively pi/6 relative to the primary windings. The susceptance elements 12-14, 38-40 are in each case operated in such a way that the susceptance in the first parallel branch 35 and the susceptance in the second parallel branch 37 each have a different arithmetic sign. In this case, the first parallel branch 35 behaves like a capacitor and the second parallel branch 37 behaves like an inductor. If both grid voltages are the same and the parallel branches are actuated antisymmetrically, the reactive power requirement of the two parallel branches is compensated for and, overall, no reactive power has to be provided by means of the two AC voltage grids. Asymmetrical actuation of the susceptance elements in the two parallel branches 35, 37 furthermore makes it possible (with approximately the same voltage) to ensure that reactive power is generated in the two AC voltage grids 21, 23.

FIG. 5 shows a further susceptance element S2 that in particular can be used in all the connecting devices shown above. In contrast to the susceptance element S of FIG. 2 (all identical and similar components and elements of FIGS. 2 and 5 are provided with the same reference signs), in this case a surge arrester 15 is provided that is arranged in a branch in parallel with the series circuit of the switching modules V1 . . . Vn. In the case of a fault, the capacitors CM and the semiconductors H can in particular be protected by means of the surge arrester 15 until the connecting device is separated from the two AC voltage grids by mechanical circuit breakers (not shown in FIG. 5).

1-15. (canceled)

16. A connecting device for connecting two n-phase AC voltage grids of the same frequency, the connecting device comprising:
n susceptance elements each having respective continuously variable susceptance values;
each of said susceptance elements configured to connect two connecting conductors, associated with one another, of the AC voltage grids, to one another and permitting an exchange of active power between the AC voltage grids to be controlled by a targeted variation of the susceptance values.

17. The connecting device according to claim 16, wherein each of said susceptance elements includes a plurality of controllable semiconductor switches and at least one DC-link capacitor.

18. The connecting device according to claim 16, wherein each of said susceptance elements includes a series circuit of switching modules, and each of said switching module includes a plurality of semiconductor switches configured to be switched off and a switching module capacitor.

19. The connecting device according to claim 16, wherein each of said susceptance elements includes a series circuit of full-bridge switching modules and an inductor configured to be connected in series between the connecting conductors that are associated with one another.

20. The connecting device according to claim 16, which further comprises a matching transformer for setting a voltage phase angle.

21. The connecting device according to claim 20, wherein said matching transformer includes an on-load tap changer.

22. The connecting device according to claim 16, which further comprises surge arresters connected in parallel with said susceptance elements.

23. The connecting device according to claim 16, wherein said n susceptance elements include 2*n susceptance elements, and a respective two of said susceptance elements connected in parallel are configured to interconnect the connecting conductors that are associated with one another.

24. The connecting device according to claim 16, which further comprises a transformer including:
a first primary winding connected to a first connecting conductor of a first AC voltage grid;
a second primary winding connected to a second connecting conductor of the first AC voltage grid;
a third primary winding connected to a third connecting conductor of the first AC voltage grid;
a first secondary winding connected to a first connecting conductor of a second AC voltage grid by a first of said susceptance elements;
a second secondary winding connected to a second connecting conductor of the second AC voltage grid by a second of said susceptance elements;
a third secondary winding connected to a third connecting conductor of the second AC voltage grid by a third of said susceptance elements;
a first tertiary winding connected to the first connecting conductor of the second AC voltage grid by a fourth of said susceptance elements;
a second tertiary winding connected to the second connecting conductor of the second AC voltage grid by a fifth of said susceptance elements;
a third tertiary winding connected to the third connecting conductor of the second AC voltage grid by a sixth of said susceptance elements; and
said secondary windings and said tertiary windings each being interconnected in star connections generating a phase offset of pi/3 relative to one another and of pi/6 relative to said primary windings.

25. A method for operating a connecting device connecting two n-phase AC voltage grids of the same frequency, the method comprising:
using a respective one of n susceptance elements to interconnect two connecting conductors associated with one another, of the AC voltage grids;
continuously varying susceptance values of each of the susceptance elements; and
controlling a transfer of active power between the AC voltage grids by a targeted variation of the susceptance values of the susceptance elements.

26. The method according to claim 25, which further comprises using the connecting device to actively set a voltage phase angle.

27. The method according to claim 26, which further comprises setting the voltage phase angle to 30°.

28. The method according to claim 26, which further comprises using a matching transformer to set the voltage phase angle.

29. The method according to claim 25, which further comprises using surge arresters connected in parallel with the susceptance elements to limit a voltage across the susceptance elements.

30. A method for operating a connecting device connecting two n-phase AC voltage grids of the same frequency, the method comprising:
providing a connecting device according to claim 24;
using a respective one of n susceptance elements to interconnect two connecting conductors associated with one another, of the AC voltage grids;
continuously varying susceptance values of each of the susceptance elements;
controlling a transfer of active power between the AC voltage grids by a targeted variation of the susceptance values of the susceptance elements;
using the susceptance elements connected to the secondary side of the transformer to form a first connecting branch;
using the susceptance elements connected to the tertiary side of the transformer to form a second connecting branch; and
actuating the susceptance elements to compensate for a reactive power requirement of the first and second connecting branches.
